(19) United States
(12) Patent Application Publication
(10) Pub. No.: US 2006/0049253 A1
(43) Pub. Date: Mar. 9, 2006

(54) Printer having integrated communication port

(75) Inventor: Norman A. Butler, Northridge, CA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: ZIH Corp.

(21) Appl. No.: 11/219,973

(22) Filed: Sep. 6, 2005

Related U.S. Application Data
(60) Provisional application No. 60/607,717, filed on Sep. 7, 2004.

(51) Int. Cl. G06F 15/12

(52) U.S. Cl. 235/432

(57) ABSTRACT

A printer having an integrated communication port for communicating with a host device is provided. The printer can include a printing mechanism for printing indicia on a media multiple communication devices for communicating data to or from the media. For example, first and second electronic communication devices of the printer can be adapted for communicating according to a select protocol with select electrical storage devices that can be provided on the media. In addition, each of the electronic communication devices can be integral to the printer, and can communicate with the host device via the integrated communication port. The host computer can be programmed to control each of the operations of the printer using an integral software program.

This application claims the benefit of U.S. Provisional Application No. 60/607,717, filed Sep. 7, 2004, which is incorporated herein in its entirety.

### BACKGROUND OF THE INVENTION

1. Field of the Invention

The present invention relates to a printer that is capable of printing indicia on a surface of a media and communicating data to and/or from an electronic storage device of the media. More particularly, the present invention relates to such a printer that includes multiple electronic communication devices, e.g., to communicate with different types of electronic storage devices on media.

2. Description of Related Art

Printers are used to print text, graphics, and other indicia on a variety of media, including media that include electronic storage devices such as magnetic strips, radio frequency identification (RFID) tags, optical devices, and the like. For example, a typical information card includes a plastic card that contains and conveys information in the form of printed indicia and/or encoded information. Information cards with magnetic strips (or “magnetic stripes”), such as credit cards and banking cards, can be “swiped” past a reader to convey the information encoded in the magnetic strip. Similarly, cards with barcode indicia can be scanned by a laser scanner, or other scanning device, to convert the visual indicia of the barcode into digital information. Information cards can also include other indicia such as fluorescent text, holograms, or encoded pixilated images that can be read with appropriate readers. Smart cards are cards that have some type of electronic circuit containing memory for storing data and some type of mechanism for accessing the memory. Contactless smart cards use an antenna or other device to communicate with a remote reader wirelessly. An RFID tag is a type of memory device for use in contactless smart cards. The RFID tag responds to a radio emission with its own emission of information stored in memory. Other types of smart cards are also used, such as cards having circuitry and contacts (e.g., gold plated contacts) which are contacted by a smart card reader for reading or writing. Further, various other types of media can also include these or other types of electronic storage devices. For example, other media such as identification labels, documents, and tracking devices can include one or more electronic storage device that is disposed in or on the media, which can be formed of plastic, paper, cardboard, foil, or the like.

Such printed and encoded media are typically prepared by separate printing and encoding operations. For example, in the case of an information card, a blank card can be fed through a printer to print the text, graphics, or other indicia on one or both sides of the card. Before or after the printing operation, the card can also be inserted into an encoding device, wherein data is communicated to the electronic storage device. By using separate operations for printing and electronic encoding, the same printer can be used for printing various cards, regardless of the type of encoding to be performed. Similarly, a single electronic communication device can be used to encode various cards, regardless of the type of printing to be performed. However, the separate operations can increase the time and expense for manufacturing the cards. Further, care must be taken to ensure that the printed and electronically encoded information for each card correspond. That is, if the cards are taken out of order between the printing and encoding operations, a card may inadvertently receive printed information that was intended for a first card and electronic data that was intended for a different card. In addition, the different devices typically require separate electrical connections to one or more host computer that controls each of the devices through multiple communication ports.

Further, the separate printing and encoding operations are typically controlled by the host computer using separate software for controlling each of the different operations. For example, if a change in the printing operation is to be effected, an operator typically accesses a first software program on the host computer. To make a change to the encoding operation, the operator instead accesses a second software program on the computer. This can complicate the operator's role, possibly increasing the time required for making changes or verifying an operation and also increasing the risk of operator error.

Thus, there exists a need for a printer that can also encode or otherwise store electronic data on a media such as an information card. The printer should be capable of storing the electronic data in multiple protocols such that the same printer can be used to selectively store the electronic data in different types of electronic storage devices. The printer should also be capable of communicating with the host computer or other controlling device via a single communication port and thereby receive signals for controlling the printing and encoding operations via one electrical connection, e.g., via one integrated electrical cable. Thus, the printer should be compatible with a software program that controls each of the operations of the printer.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a section view schematically illustrating a printer according to one embodiment of the present invention;

FIG. 2 is a perspective view illustrating an exemplary media card that can be processed with a printing and reading/writing operation of the printer of FIG. 1 according to one embodiment of the present invention;

FIG. 3 is a block diagram schematically illustrating the printer according to another embodiment of the present invention; and

FIG. 4 is a schematic diagram illustrating a graphical user interface for use in conjunction with the control of a printer according to one embodiment of the present invention.

### DETAILED DESCRIPTION OF THE INVENTION

The present invention provides a printer that is configured to communicate with a host device for receiving a signal and, in response to the signal, printing indicia on a media and/or electronically storing data on an electronic storage device of the media. According to one embodiment of the present invention, the printer includes a print device for printing indicia, such as graphics, text, or the like on one or more surfaces of the media. A controller can be configured to control the print device. The printer also includes first and second electronic communication devices for communicating with the media according to a select protocol. That is, each electronic communication device can be configured to store data on the media and/or read data therefrom using different communication protocols. For example, each of the electronic communication devices can be adapted for various types of communication with various types of electronic storage devices that may be provided on the media. In particular, the media can include a magnetic strip, a contactless (i.e., non-contact) device such as an RFID tag or other contactless memory circuitry, a contact device such as an integrated circuit with contact terminals, and the like. Alternatively, one or more of the electronic communication devices can be configured to store or read data by disposing or detecting material on the media, e.g., fluorescent text, a hologram, encoded pixilated images, or the like. In any case, the printer can include multiple types of electronic communication devices, each of which can communicate using a different communication protocol, so that the printer can read and/or write to various types of media.

Each electronic communication device of the printer can be integral to the printer so that the printer can perform each of the printing and electronic communication operations. Further, the printer can perform both operations as part of a combined process, i.e., while the media is being fed through the printer in one or more pass along a feed or conveyance path thereof. The printing and electronic communication can be controlled by a single controller, such as a microprocessor or the like that communicates with each of the electronic communication devices. In addition, the electronic communication devices can communicate with an external controller, such as a host computer, which can be the same host computer that controls the operation of the printer functions of the printer. In fact, the printer can communicate with the host computer or other controller via a single, integrated communication port and/or a single communication cable. For example, the cable can include conductive elements configured for communication using one or more protocols such as parallel, serial, universal serial bus (USB), Ethernet, and the like for controlling each of the different printing and reading/writing operations. According to one aspect of the invention, the host computer, the cable, and the communication port of the printer are configured for communicating signals for printing as well as communicating with the media via the different electronic communication devices so that different types of communication can be performed. That is, the host device can communicate a signal to the printer via the integrated communication port, and the signal can be representative of the indicia and data to be encoded on the media. The electronic communication devices can also be configured to read data from the media according to the respective protocols, and any data read from the media can be communicated to the host via the same integrated communication port.

In addition, the host computer can be programmed to control each of the operations of the printer using an integral software program. For example, the host computer can be configured to perform a plurality of operations of an integral software program, which is configured to control the printing of the indicia by the print device and the storing of the data by the first and second electronic communication devices. The integral software program can provide a single user interface for controlling the printing of the indicia by the print device and the storing of the data by the first and second electronic communication devices. Thus, an operator can control the printing and reading/writing communication operations of the printer using one software program, and the software program can have a single user interface therefor.

According to one embodiment, the present invention provides a method of printing on a media in a printer and selectively electronically storing data on the media according to one of multiple communication protocols in response to a signal received from a host device. A signal that is representative of an indicia and data is received from the host device via an integrated communication port. The indicia is printed on a surface of the media according to the signal. One of multiple communication protocols is selected for storing the data, and, in some cases, one of multiple electronic communication devices is selected according to the select communication protocol. Each electronic communication device can be configured to store the data on the media using a different communication protocol. The communication devices and/or communication protocols can also be used for reading data from the media. Thus, the data can be stored on the media according to the signal using the select communication protocol and/or the select communication device. The printing, selecting, and storing operations can be controlled and/or performed by a controller, and these operations can be performed during a combined operation, e.g., while the media is fed in one or more passes through the printer. The printing and storing operations can be controlled by a single, i.e., integral, software program that includes a plurality of operations. Further, a single user interface can be provided for controlling the printing of the indicia and the storing of the data.

According to another embodiment, the present invention also provides a computer program product for communicating between a host device and a printer. The computer program product includes a computer-readable storage medium having computer-readable program code portions stored therein. The computer-readable program code portions can include a first executable portion for communicating a signal representative of an indicia and data to the printer so that the signal controls the printer to print the indicia on a surface of a media and store the data on the media according to a select one of multiple communication protocols. The first executable portion can be configured to select one of multiple electronic communication devices of the printer according to the select communication protocol and thereby control the select communication device to store the data on the media. For example, the data can be stored on a magnetic strip, an RFID tag, or an integrated circuit, or the data can be stored using fluorescent text, a hologram, or encoded pixilated images. The first executable portion can be configured to communicate with the printer via the integrated communication port using a parallel port, a serial port, a universal serial bus (USB) port, or an Ethernet port, and communication by each type of port can be performed using a communication protocol that corresponds to the particular type of port that is used, e.g., a USB protocol can be used when communicating via a USB port. For example, the first executable portion can communicate the signal to a controller of the printer via an integrated communication port so that the controller is configured to receive the signal and print the indicia and store the data according to the signal. A second executable portion of the computer program product can provide an integral user interface for controlling the printing of the indicia and the storing of the data. A third executable portion can also be provided to read data from the media according to the select communication protocol.

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

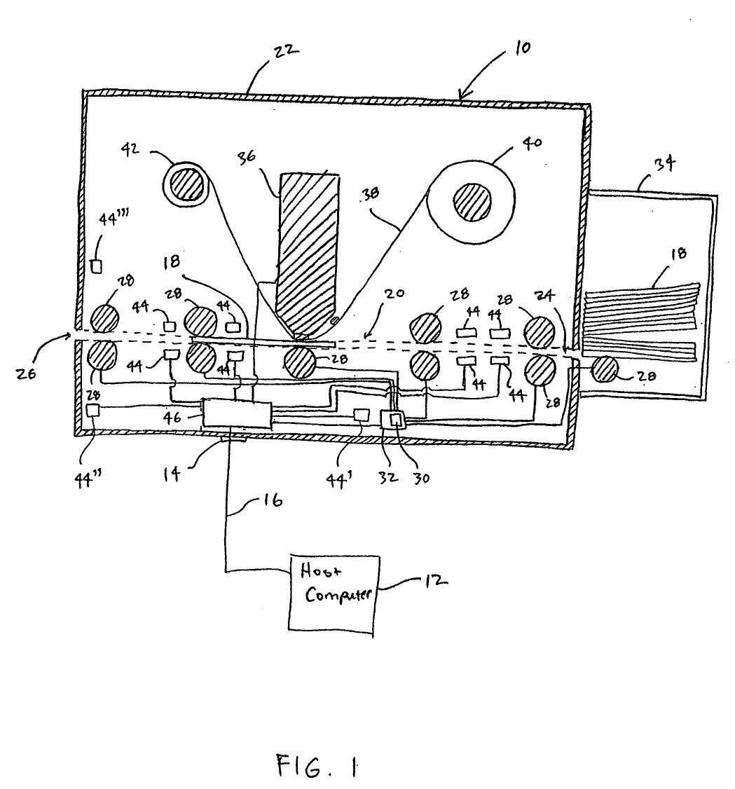

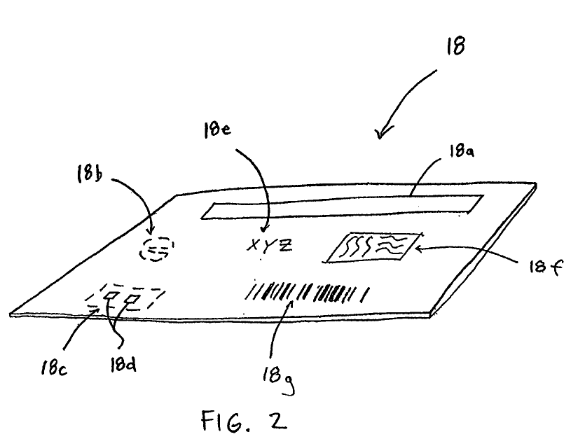

Referring now to the figures and, in particular, to FIG. 1, there is shown a printer 10 according to one embodiment of the present invention. The printer 10 is electrically connected to a host computer 12 via an input/output (I/O) port 14 and a data communication cable 16. The printer 10 illustrated in FIG. 1 is adapted for printing cards 18, such as information cards. As shown in FIG. 2, the card 18 can include one or more magnetic strips 18a, contactless devices such as RFID tags 18b, contact devices such as an integrated circuit 18c with a memory and contact terminals 18d, fluorescent text 18e, holograms 18f, a barcode 18g or otherwise encoded pixilated image, or the like.

The printer 10 can include features of the P310i, P330i, P430i, and P530i Printers available from Zebra Technologies Corp., which are generally configured for printing cards. However, it is appreciated that the printer 10 can alternatively be adapted to receive other types of media such as labels, paper or cardboard sheets or strips, envelopes, tickets, and the like. As illustrated in FIG. 1, the printer 10 defines a feed or conveyance path 20 that extends through a housing 22 of the printer 10 from an entrance 24 to an exit 26. The conveyance path 20 generally defines the path of travel of the media, such as the plastic cards 18, through the printer 10. Rotatable rollers 28 or other media support and transport devices, such as one or more belts, are provided along the conveyance path 20 to feed or convey the media therethrough. The rollers 28 are typically rotated by one or more electric motor 30, which is controlled by a motor driver 32, to feed the cards 18 or other media along the conveyance path 20 through the printer 10 during operation. Thus, during a typical printing operation of the printer 10, a stack of the cards 18 can be provided in a hopper 34 proximate to the entrance 24 of the conveyance path 20, and the cards 18 can be individually fed from one side of the stack and then fed along the conveyance path 20 to the exit 26.

As is known in the printing industry, a head 36 of the printer 10 can be a device for disposing a dye onto stock media. For example, a thermal dye ribbon 38 can extend from a supply spool 40 to a take-up spool 42 with the ribbon 38 disposed between the head 36 and one of the cards 18 in the conveyance path 20. Dyes of one or more colors are disposed on the ribbon 38, and the head(s) 36 is configured to press the ribbon 38 against the card 18 and/or heat the ribbon 38 at particular locations so that the dye in the particular locations of the ribbon 38 is transferred to the card 18. Such a thermal printing operation is described, e.g., in U.S. Pat. No. 6,151,037 to Kaufman, et al.; U.S. Pat. No. 5,978,004 to Ehrhardt; and U.S. Pat. No. 5,657,066 to Adams, et al., each of which is assigned to the assignee of the present application, and the contents of each of which are incorporated herein in their entirety by reference. In other embodiments of the present invention, the printer can be alternatively configured to print, e.g., using a retransfer printing mechanism or other printing mechanisms.

As each card 18 is fed along the conveyance path 20 of the printer 10, the head 36 can dispose one or more colors onto the card 18 in a predetermined pattern. In some cases, the ribbon 38 can define repeating frames of panels, each panel having a dye of a different color than the other panels of the same frame. For example, each frame can include panels that are yellow, magenta, and cyan, respectively. The cards 18 can be alternately advanced and retracted in opposite directions along the conveyance path 20 so that each card 18 is fed under the head 36 multiple times, during which the head 36 can print different colors from the different panels of a frame.

The printer 10 is also configured to communicate data to and/or from the media using one or more communication devices 44. The devices 44 can generally be used to read data from the media and/or write data to the media. For example, one or more of the devices 44 can be adapted to communicate with a particular type of electronic storage device provided on the media, i.e., on a surface of the media, embedded within the media, or otherwise associated with the media. Thus, the printer 10 can be used to selectively communicate with the media according to the type of media and the desired form of data storage. In fact, the printer 10 can be used to process various types of media and can communicate accordingly using one or more protocols for each media. The communication devices 44 can be disposed on either or both sides of the conveyance path 20, and, as illustrated in FIG. 1, the devices 44 can be located at various positions throughout the printer 10. In one particular embodiment, the printer 10 includes two or more communication devices 44 that are disposed internal to the housing 22 of the printer 10 and configured to communicate using at least two different protocols. Any number of the communication devices 44 can be activated during the processing of each media.

In one embodiment, one or more of the communication devices 44 can be a modular component that can be easily replaced without significantly interrupting the operation of the printer 10. For example, each of the communication devices 44 disposed within the housing 22 of the printer 10 can be configured to be interchangeable with each other and/or with other communication devices. That is, the communication devices 44 can be similar in size, shape, or other physical configuration. In some cases, the communication devices 44 can also be configured to connect to the printer 10 using similar electrical connections. Thus, the communication devices 44 can be quickly and easily replaced, e.g., if it is desired to communicate with the media using a communication device that is not presently provided in the printer 10, to adjust one of the communication devices 44 in a particular position or orientation to correspond to a particular type of media being processed, or if any of the communication devices 44 requires maintenance or repair.

The printer 10 includes a controller 46 for communicating with the host 12 and controlling the operations of the printer 10. As shown in FIG. 1, the controller 46 can be a single integral device that controls the feeding, printing, reading, writing, and other operations of the printer 10. However, it is also appreciated that the functions of the controller 46 can be shared by multiple devices, such as a separate print controller, communication controller, motor driver controller, and the like.

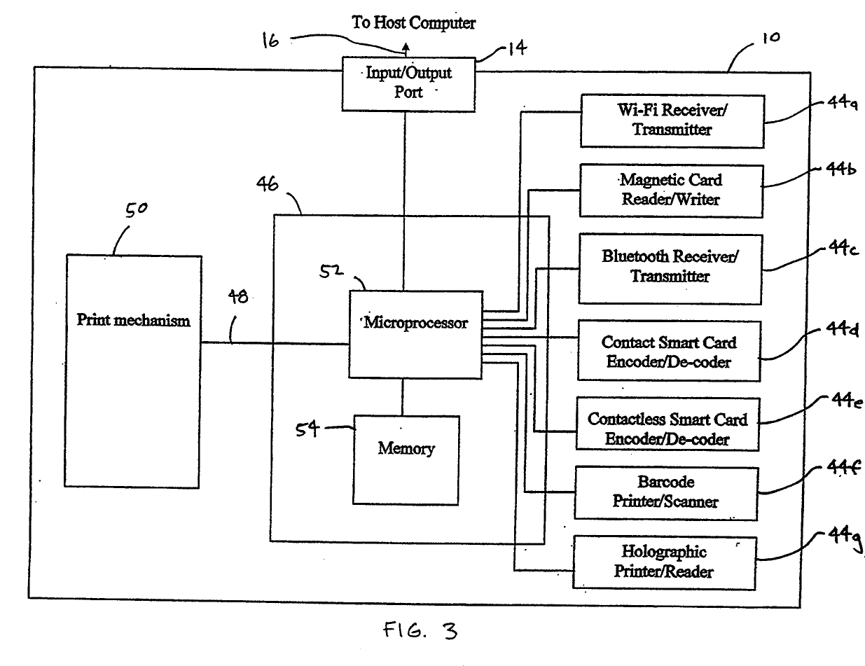

FIG. 3 illustrates a controller 46 according to one embodiment of the present invention. The controller 46 is configured to communicate with the host computer 12 via the cable 16 and I/O port 14. The controller 46 is also configured to communicate via an internal electrical connection 48 with the print mechanism 50, i.e., the roller motor(s) 30 and/or motor driver 32, one or more print heads 36, a printer display, and other equipment of the printer 10. The controller 46 includes a microprocessor 52 or other electrical control device capable of receiving a signal from the host computer 12 and responding by controlling the print and communication operations accordingly. A memory 54 can also be provided, e.g., for buffering signals from the host computer 12, for storing operating instructions, and the like. Thus, the host computer 12 can perform a print operation by sending a signal to the controller 46 instructing the controller 46 to control the print mechanism 50 accordingly to feed, i.e., convey, the media and print text, graphics, or other indicia on one or both sides of the media.

The microprocessor 52, or alternatively another device of the controller 46, is also configured to communicate with the communication devices 44, designated by reference numerals 44a-44g and referred to collectively by numeral 44. As shown in FIG. 3, the controller 46 is electrically connected to a Wi-Fi receiver/transmitter 44a, a magnetic card reader/writer 44b, a Bluetooth receiver/transmitter 44c, a contact smart card encoder/de-coder 44d, a contactless smart card encoder/de-coder 44e, a barcode printer/scanner 44f, and a holographic printer/reader 44g. Each of the communication devices 44 is configured to communicate using a different protocol. For example, the Wi-Fi receiver/transmitter 44a is configured to detect and/or generate Wi-Fi signals for communicating with another Wi-Fi device, such as a Wi-Fi receiver disposed on the card 18 or other media. Similarly, the Bluetooth receiver/transmitter 44c is configured to detect and/or generate a Bluetooth wireless signal. The first smart card encoder/de-coder 44c is a “contact” device configured to transmit and/or receive a signal for writing to and/or reading from a smart card via electrical contacts that touch corresponding contacts of the smart card. For example, the encoder/decoder 44c can communicate data to and/or from an integrated circuit with a memory that is disposed on the card 18 via contacts 18d. The second smart card encoder/de-coder 44d is a contactless, i.e., non-contact, device that is configured to transmit and/or receive a radio frequency signal to communicate data to and/or from an electronic data storage device on the media, such as an RFID tag or an electronic article surveillance (ESA) RF resonant security element. The magnetic card reader/writer 44b includes a magnetic head that is configured to read and write to a magnetic strip on a media. The barcode printer/scanner 44f is configured to print and/or scan a bar code or other printed indicia on the media. For example, the bar code can be scanned by directing a laser or other optical radiation at the barcode and detecting reflectance therefrom. In some cases, the printing mechanism 50 can be used to print the barcode on the media, and the barcode communication device 44f can be a scanner that is configured to read but not write the bar code. Similarly, the holographic printer/reader 44g can be configured to dispose material for forming a holographic image and/or to detect such material for decoding the image, e.g., a hologram formed as an overlay on the media. However, in some embodiments, the hologram communication device 44g can be configured to detect the hologram, which can be printed by the printing mechanism 50 or otherwise. Further, each of the barcode and hologram communication devices 44f, 44g can alternatively be configured for printing or detecting other indicia such as alphanumeric symbols, text, graphics, colored markings, or the like. It is appreciated that the printer 10 can include any of these or other communication devices.

The communication devices 44 can be provided at various locations throughout the printer 10 and can be positioned adjacent the conveyance path 20 or remotely from the conveyance path 20. For example, in one embodiment, one or more communication device 44 is provided at a position that is spaced from the conveyance path 20 and configured to communicate with a contactless device, such as an RFID tag 18b, on the card 18 without contacting the card 18. Exemplary positions for the communications devices 44 that are remote from the conveyance path 20 are illustrated in FIG. 1 and indicated by reference numerals 44′, 44″, 44′″. The remotely positioned communication devices 44′, 44″, 44′″ are also referred to collectively with the other communication devices by reference numeral 44.

In addition, the communication devices 44 can be configured to communicate with the card 18 at various times throughout the processing of the card 18 in the printer 10. For example, as illustrated in FIG. 1, one of the communication devices 44′ is provided generally below the head 36 such that the communication device 44′ is in sufficient proximity with (though not adjacent to) the card 18 for communicating with the card 18 when the card is substantially positioned below the head 36 and available to the head 36 for printing. In particular, the communication device 44′ can be a contactless device, such as a contactless smart card encoder/de-coder, and the communication device 44′ can be configured to read from and/or write to the card 18, such as to an RFID tag 18b on the card 18, while the head 36 is printing on the card 18 or while the card is otherwise positioned and ready for printing by the head 36. Thus, in some cases, the printer 10 can print on the card 18 while simultaneously or substantially simultaneously communicating with one or more data storage devices on the card 18, such as a magnetic strip 18a, RFID tag 18b, integrated circuit 18c, fluorescent text 18e, hologram 18f, barcode 18g, or the like.

As noted above, the host computer 12 and the controller 46 can communicate via the I/O port 14 and the cable 16. In particular, the host computer 12 can transmit signals to the controller 46 via the cable 16 and I/O port 14 for controlling the operation of the printer 10. Typically, the signal transmitted by the host computer 12 includes information for controlling an operation for printing the media by the printer 10, as well as information for controlling the communication with the media using the communication devices 44. According to one embodiment of the present invention, the host computer 12 issues a signal that includes communication data corresponding, at least in part, to the particular communication device 44 that is to be used in a reading/writing operation of the media. For example, if it is desired for the controller 46 to encode data on the media using a select one of the communication devices 44, information identifying or otherwise describing the particular communication device (or the type of communication or media) can be communicated to the host computer 12 by the controller 46, the operator, or otherwise. Thereafter, the host computer 12 can issue a signal using an appropriate protocol. That is, the data transmitted to the controller 46 can be in a format for use by the select communication device 44. For example, if a magnetic strip on the media is to be encoded with binary data, the data can be communicated to the controller 46 in a binary format. Alternatively, if graphical information is to be stored on the media, the data can be communicated to the controller 46 in any of various graphical formats. In other embodiments of the present invention, the controller 46 can be configured to format or otherwise process the data before the data is delivered to the appropriate communication device 44. Thus, in some cases, the host computer 12 can provide a signal that is received by the controller 46 and thereafter used by the controller 46 for communicating with any of various types of media.

In some cases, the controller 46 can also transmit information to the host computer 12 via the cable 16 and I/O port 14. For example, if any of the communication devices 44 are used for reading data from the media, that data can be communicated by the controller 46 to the host computer 12. In addition, the controller 46 can communicate other information to the host computer 12, such as the operational status of the printer 10, the progress or success of the printer 10 in a printing and reading/writing operation, the type of media in the printer 10, and the like.

Thus, the cable 16 and I/O port 14 can provide an integrated connection by which the printer 10 can receive data for printing the media and can receive and/or transmit data that is being written to and/or read from the media, even if the data is provided in different protocols. In some cases, the controller 46 can include a multiplexer that transmits portions of the signal from the host computer 12 to a respective one of the devices 44, 50. Thus, a serial type communication between the host computer 12 and the controller 46 can be used to communicate data for simultaneous or generally contemporaneous printing and reading/writing operations.

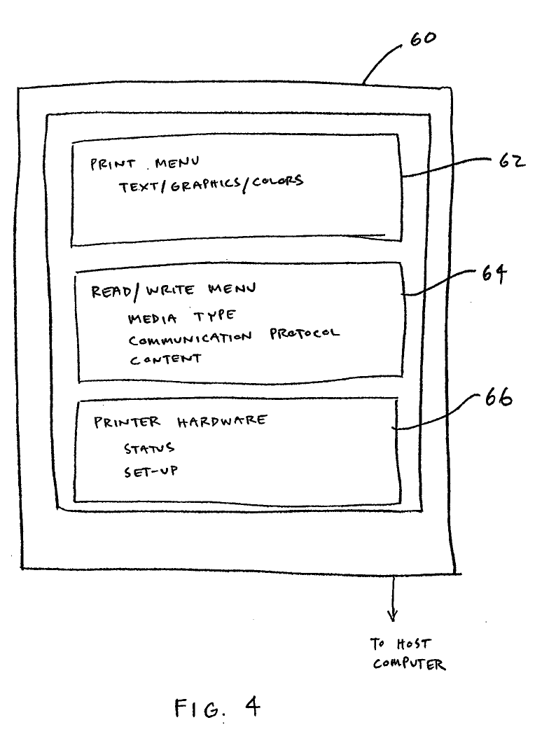

In addition, the printer 10 can be controlled by a single driver software program that is capable of controlling each of the printing and reading/writing operations of the printer 10. In this regard, FIG. 4 schematically illustrates a display 60, such as a cathode ray tube or liquid crystal display in communication with the host computer 12. The display 60 can be used to graphically output information to the operator (and request input from the operator) regarding the host computer 12, the printer 10, and operations thereof. In particular, as illustrated in FIG. 4, the driver software program for controlling the printer 10 can provide a graphical user interface on the display 60. The graphical user interface can be used to communicate information relating to both the printing and reading/writing operations of the printer 10. For example, the graphical user interface can provide a first submenu 62 for controlling the printing operation and a second submenu 64 for controlling the reading/writing operations. Each submenu 62, 64 can provide features for accessing information relating to the status of the respective operation and for entering information for changing the operation, e.g., for changing the text, graphics, colors, or the like that are to be printed on the media, or for indicating to the host computer 12 a change to the media type being used, the data to be encoded or read, and the like. In this regard, the software can include instructions for inputting information from the operation, e.g., using typical input devices such as a keyboard, mouse, touchpad, trackball, microphone, or the like. A third submenu 64 can also be provided for accessing options relating to both of the printing and reading/writing operations, e.g., for verifying or changing the status or set-up of the printer 10 with the host computer 12, such as by adjusting aspects of the connection therebetween.

Many modifications and other embodiments of the inventions set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A printer configured to communicate with a host device for receiving a signal and, in response to the signal, printing indicia on a media and selectively electronically storing data on the media according to one of multiple protocols, the printer comprising:
a print device for printing the indicia on a surface of the media;
a first electronic communication device for storing the data on the media according to a first protocol;
a second electronic communication device for storing the data on the media according to a second protocol different than the first protocol;
at least one controller configured to control the print device and the electronic communication devices; and
an integrated communication port configured to receive from the host device at least one signal representative of the indicia and the data, the communication port being in electrical communication with the controller such that the controller is configured to receive the signal and print the indicia and store the data according to the signal.

2. A printer according to claim 1 wherein the first electronic communication device is configured to read data from the media according to the first protocol and the second electronic communication device is configured to read data from the media according to the second protocol.

3. A printer according to claim 1 wherein the each of the first and second electronic communication devices is adapted to store the data on at least one of the group consisting of a magnetic strip, an RFID tag, and an integrated circuit.

4. A printer according to claim 1 wherein at least one of the electronic communications devices is configured to communicate with the media using at least one of the group consisting of fluorescent text, a hologram, and encoded pixilated images.

5. A printer according to claim 1 wherein the electronic communication devices are integral to the printer and the printer is configured to print the indicia on the media and store the data on the media with at least one of the electronic communication devices during a combined operation while the media is fed through the printer.

6. A printer according to claim 1 wherein the integrated communication port is configured as one of the group consisting of parallel, serial, universal serial bus (USB), and Ethernet ports such that the integrated communication port is configured to receive the signal representative of the indicia and the data using a corresponding communication protocol.

7. A printer according to claim 1 further comprising the host computer configured to perform a plurality of operations of an integral software program configured to control the printing of the indicia by the print device and the storing of the data by the first and second electronic communication devices.

8. A printer according to claim 7 wherein the integral software program is configured to provide a single user interface for controlling the printing of the indicia by the print device and the storing of the data by the first and second electronic communication devices.

9. A method of printing on a media in a printer and selectively electronically storing data on the media according to one of multiple communication protocols in response to a signal received from a host device, the method comprising:
receiving a signal from the host device via an integrated communication port, the signal being representative of an indicia and data;
printing the indicia on a surface of the media according to the signal;
selecting one of multiple communication protocols for storing the data; and
storing the data on the media according to the signal using the select communication protocol.

10. A method according to claim 9 wherein said selecting step further comprises selecting one of multiple electronic communication devices according to the select communication protocol, each of the electronic communication devices being configured to store the data on the media using a different communication protocol.

11. A method according to claim 9, further comprising providing a controller configured to control said printing, selecting, and storing steps.

12. A method according to claim 9, further comprising reading data from the media according to the select communication protocol.

13. A method according to claim 9 wherein said storing step comprises storing the data on at least one of the group consisting of a magnetic strip, an RFID tag, and an integrated circuit.

14. A method according to claim 9 wherein said storing step comprises storing the data using at least one of the group consisting of fluorescent text, a hologram, and encoded pixilated images.

15. A method according to claim 9 wherein said printing and storing steps are performed during a combined operation while the media is fed through the printer.

16. A method according to claim 9 wherein said receiving step comprises receiving the signal from the host device via the integrated communication port having at least one of the group consisting of a parallel port, serial port, universal serial bus (USB) port, and Ethernet port such that the integrated communication port is configured to receive the signal representative of the indicia and the data using a corresponding communication protocol.

17. A method according to claim 9, further comprising performing a plurality of operations of an integral software program configured to control the printing of the indicia and the storing of the data.

18. A method according to claim 17, further comprising providing a single user interface for controlling the printing of the indicia and the storing of the data.

19. A computer program product for communicating between a host device and a printer, the computer program product comprising a computer-readable storage medium having computer-readable program code portions stored therein, the computer-readable program code portions comprising:
a first executable portion for communicating a signal representative of an indicia and data to the printer, such that the signal controls the printer to print the indicia on a surface of a media and store the data on the media according to a select one of multiple communication protocols; and
a second executable portion for providing an integral user interface for controlling the printing of the indicia and the storing of the data.

20. A computer program product according to claim 19 wherein the first executable portion is configured to select one of multiple electronic communication devices of the printer according to the select communication protocol and thereby control the select communication device to store the data on the media using the select communication protocol.

21. A computer program product according to claim 19, further comprising a third executable portion configured to read data from the media according to the select communication protocol.

22. A computer program product according to claim 19 wherein the first executable portion is configured to store the data on at least one of the group consisting of a magnetic strip, an RFID tag, and an integrated circuit.

23. A computer program product according to claim 19 wherein the first executable portion is configured to store the data using at least one of the group consisting of fluorescent text, a hologram, and encoded pixilated images.

24. A computer program product according to claim 19 wherein the first executable portion is configured to communicate with the printer via the integrated communication port having at least one of the group consisting of a parallel port, serial port, universal serial bus (USB) port, and Ethernet port using a corresponding communication protocol.

25. A computer program product according to claim 19 wherein the first executable portion is configured to communicate the signal to a controller of the printer via an integrated communication port such that the controller is configured to receive the signal and print the indicia and store the data according to the signal.
